(19) United States
(12) Patent Application Publication
(10) Pub. No.: US 2026/0201958 A1
(43) Pub. Date: Jul. 16, 2026

(54) MECHANICAL SEAL ARRANGEMENT

(71) Applicant: EagleBurgmann Germany GmbH & Co. KG, Wolfratshausen (DE)

(72) Inventors: Klaus Lang, Eurasburg (DE); Stephan Rankl, Gilching (DE)

(73) Assignee: EagleBurgmann Germany GmbH & Co. KG, Wolfratshausen (DE)

(21) Appl. No.: 19/132,269

(22) PCT Filed: Oct. 26, 2023
(86) PCT No.: PCT/EP2023/079904

§ 371 Date: May 22, 2025

(30) Foreign Application Priority Data
Nov. 29, 2022 (DE) 10 2022 131 503.7

(51) Int. Cl. F16J 15/34

(52) U.S. Cl. CPC F16J 15/3464

(57) ABSTRACT

The invention relates to a mechanical seal arrangement, comprising a mechanical seal (2) having a rotating slide ring (3) having a first sliding surface (30) and a stationary slide ring (4) having a second sliding surface (40), wherein a sealing gap (5) is defined between the sliding surfaces (30, 40), a torque device (6) for transmitting a torque between one of the slide rings and a slide ring carrier (31, 41), wherein the torque device (6) comprises a plurality of transmission elements (60, 70) which are configured for transmitting torque between the slide ring carrier (31, 41) and the slide ring such that a total torque is divided over the plurality of transmission elements (60, 70), wherein the slide ring carrier (31, 41) comprises first receiving openings (61) having a cross-section that is curved and the slide ring comprises second receiving openings (62) which have a cross-section that is curved, and wherein the transmission elements (60, 70) are arranged in the first and second receiving opening (61, 62).

The present invention relates to a mechanical seal arrangement having a significantly improved possibility for transmission of torque from and to slide rings, in particular ceramic slide rings.

Mechanical seal arrangements are known in various embodiments from the prior art. In this case, a problem area is starting the mechanical seal from a standstill situation under high pressure of the medium to be sealed. When the mechanical seal arrangement is at standstill, the slide rings are typically pressed against one another by spring means and the pressure of the medium, in order to as far as possible ensure sealing at the sealing gap between the sliding surfaces of the slide rings. It tends to be the case here that the sealing is better the higher the preload force on the slide rings is. However, this then leads to problems when starting the mechanical seal arrangement from standstill, because a very high torque occurs here, which is transmitted from the starting shaft to the rotating slide ring, for example via a slide ring carrier. In the same way, on account of the contact during standstill upon starting of the mechanical seal arrangement a very high torque also arises on the stationary slide ring, which is held in a fixed manner by a stationary slide ring carrier or a housing. The same problem also occurs in the case of mechanical seals for sealing media in particular in the case of high pressures, for example during pumping or agitator seals, since the slide rings, in the standstill state, are additionally loaded by the high pressure and pressed against one another. For example pressed-in pins are used for transmitting torque between the slide ring carrier and the slide ring. However, this is not possible in the case of ceramic slide rings on account of the brittle nature of the material of the slide rings. Shrink connections between the slide ring carrier and slide ring are also known, as a result of which, however, undesirably high stresses can be introduced into the slide ring which can lead to cracks in the slide ring material and possibly undesirably short service lives of the slide rings. In particular in the case of agitator seals, frequently additional so-called standstill seals also have to be used in order to ensure the tightness of the mechanical seal arrangement during standstill.

The object of the present invention is therefore that of providing a mechanical seal arrangement which allows for an improvement of a transmission of torque between slide rings and slide ring carriers, both in the case of rotating and in the case of stationary slide rings, with a simple design and simple, cost-effective producibility.

This object is achieved by a mechanical seal arrangement having the features of claim 1. The dependent claims disclose preferred developments of the invention.

The mechanical seal arrangement according to the invention, having the features of claim 1, has the advantage, in contrast, that a significant improvement of a transmission of torque between the slide ring carrier and slide ring or slide ring and slide ring carrier is possible. In particular, damage to the slide rings due to excessively high torques can be prevented. Furthermore, additional standstill seals are also not necessary. Furthermore, according to the invention a very gentle torque introduction between the torque-transmitting components can be made possible. Furthermore, a force introduction point K can be purposely selected, wherein in particular a direction of the force and/or a strength of the introduced force can be defined.

This is achieved according to the invention in that the mechanical seal arrangement comprises a mechanical seal which comprises a rotating slide ring having a first sliding surface and a stationary slide ring having a second sliding surface, wherein a sealing gap is defined between the sliding surfaces. Furthermore, the mechanical seal arrangement comprises a torque device for introducing a torque into and/or out of at least one of the slide rings. In this case, the torque device comprises a plurality of transmission elements which transmit torque between a slide ring carrier and the slide ring. In this case, torque can be transmitted in both directions, i.e. from the slide ring carrier into the slide ring or from the slide ring into the slide ring carrier. In this case, the torque transmission takes place in such a way that a total torque is divided over the plurality of the individual transmission elements. In this case, the slide ring carrier comprises first receiving openings having a cross-section that is curved. The slide ring comprises second receiving openings having a cross-section that is curved. The first and second receiving openings are preferably semicircular in section. Furthermore, the transmission elements are arranged simultaneously in the first and second receiving opening and are in contact with the slide ring carrier and the slide ring. In this case, no press fit is formed between the transmission elements and the first and second receiving opening. Since a plurality of transmission elements is provided, and all the transmission elements participate in the torque transmission, a significant reduction in the respective magnitude of a transmitted torque results, corresponding to the number of transmission elements at a given maximum torque. Stresses at the contact regions of the torque device can also be reduced.

The transmission elements are particularly preferably rolling elements which are configured for performing a rolling process between the slide ring carrier and the slide ring in the case of torque transmission. The rolling process is relatively small during operation, and is performed only over a small angle of rotation, preferably smaller than 2°, in particular smaller than 1°.

The rolling bodies are preferably cylinders. Further preferably, all the rolling bodies are configured the same. In this case, the cylinders are arranged having their cylinder axis in parallel with the central axis of the mechanical seal. As a result, a rolling movement in the peripheral direction of the slide rings is possible, which leads to a variation of the force introduction point K between the torque-transmitting components. By means of the rolling bodies, in particular the force introduction point can be moved away from an outside diameter of the slide ring and thus away from a fragile edge at the receiving openings which are provided on the outer periphery of the slide ring. As a result, stress peaks, which may possibly lead to chipping on the material of the slide ring, in particular in the region of the edge of the receiving openings, can be prevented. This is very advantageous in particular when using ceramic slide rings.

Further preferably, a first radius R1 of the rolling bodies is smaller than a second radius R2 of the first receiving openings in the slide ring carrier, and/or the first radius R1 of the rolling bodies is smaller than a third radius R3 of the second receiving openings in the slide ring. That is to say that, at the contact point, the first radius R1 is always smaller than or equal to the second radius R2 and/or the third radius R3. As a result, a force direction which acts in the case of the transmission of torque to the torque-receiving component, can be set. In particular, the force introduction point K can be moved away from an outer periphery of the slide ring at which the edge of the second receiving opening is located. Furthermore, it is possible, in the case of starting of the mechanical seal arrangement from a standstill situation, that the selection of the different radii of the rolling bodies and the receiving openings results, upon starting, in a brief sliding surface deformation occurring in a region between two neighboring rolling bodies. This makes it possible, in particular in the case of high pressures, for the pressurized medium to be sealed to flow briefly into these sliding surface deformations and support raising of the slide rings. Selecting the force introduction point K thus makes it possible for a certain waviness on the sliding surface, in particular on the pressurized side, in particular of the outer periphery of the slide ring, to be achieved in a purposeful manner for the starting process of the mechanical seal arrangement, which leads, in the axial direction, on the sliding surface, to retracted troughs in the region of the rolling bodies and to protruding bulges in the region between the rolling bodies, such that the medium can briefly flow into the sealing gap and supports raising of the sliding surfaces during the starting process.

Preferably the radii R2 and R3 of the second and third receiving opening are the same size.

Further preferably, in an alternative embodiment of the invention the transmission elements comprise a first and a second body which are interconnected by means of a connection device. The first body comprises a curved first contact surface for contact to the first receiving opening in the slide ring carrier, and the second body comprises a curved second contact surface for contact with the second receiving opening in the slide ring.

The connection device preferably comprises one or more rods between the first and second body. As a result, the first and second body are interconnected only at partial regions, such that there is a certain elasticity of the transmission elements configured in this way. Particularly preferably, the rods and/or the first and second body are produced from a material having a greater elasticity than the slide ring and the slide ring carrier. Further preferably, the connection device comprises a framework-like connection which is in particular rigid in the radial direction.

The first body and/or the second body are preferably rod-shaped components, in particular having an elliptical cross-section. Alternatively it is also possible for the first and second body to be configured as cylinders, preferably having different diameters.

Further preferably, the first and the second body have different cross-sections.

Further preferably, the first and second receiving opening are arranged in an n-gon, wherein N is a whole number. Particularly preferably N=6, wherein the torque-introducing positions are uniformly distributed along the periphery of the slide ring. The torque transmission to and from the slide ring preferably takes place at the outer periphery of the slide ring.

Further preferably, torque devices for torque transmission are provided both on the rotating slide ring and on the stationary slide ring. The torque devices on the rotating and stationary slide ring preferably have the same geometric design.

Further preferably, the torque device is arranged at the first and second recess in such a way that the force introduction point K is not located at a jacket diameter of the slide ring and the slide ring carrier.

The mechanical seal arrangement preferably comprises ceramic slide rings, in particular made of SiC or WC.

Preferred embodiments of the invention are described in detail in the following, with reference to the accompanying drawings, in which:

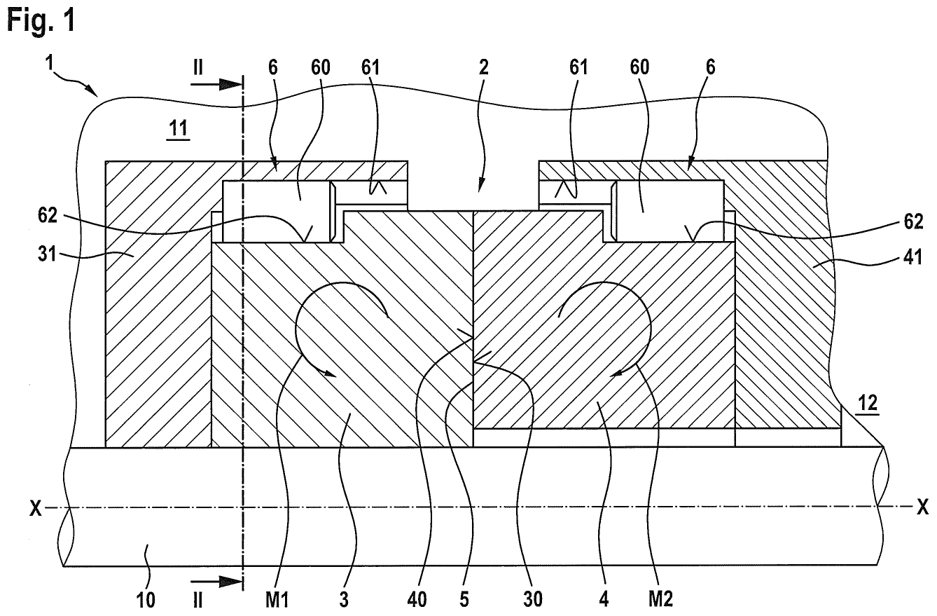

FIG. 1 is a schematic sectional view of a mechanical seal according to a first embodiment of the invention,

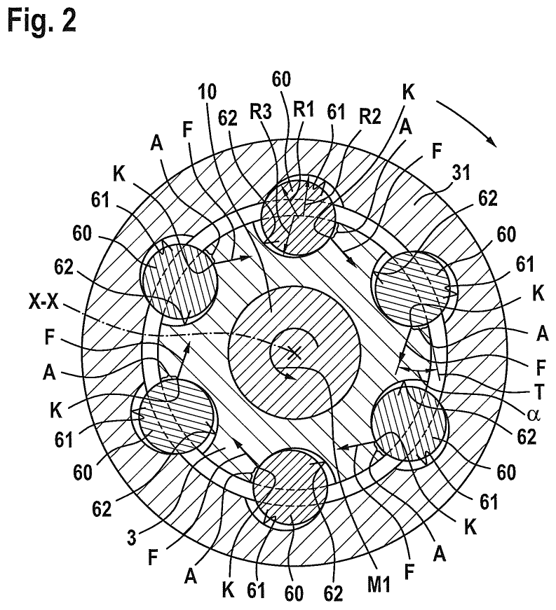

FIG. 2 is a schematic sectional view along the line II-II of FIG. 1,

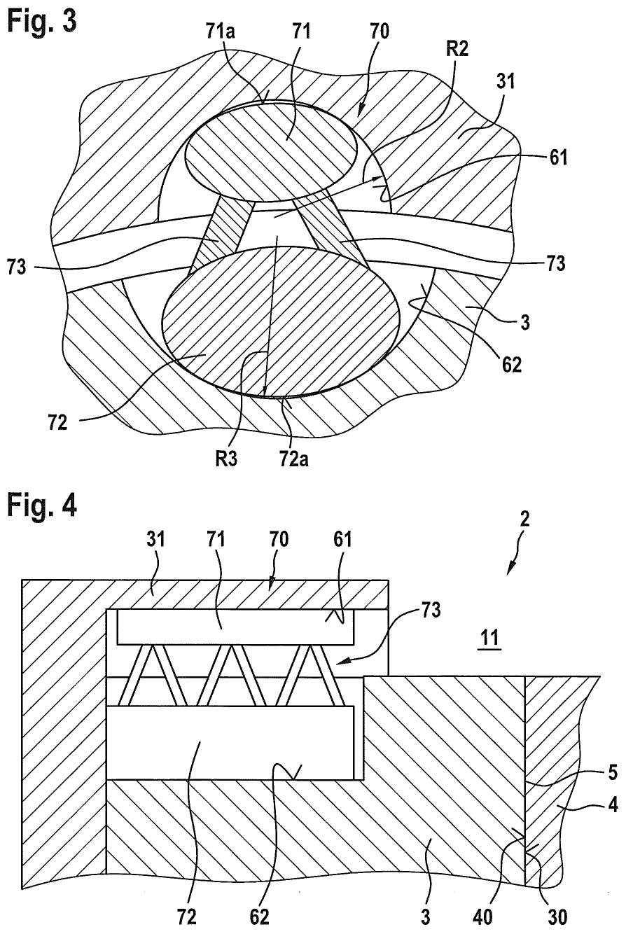

FIG. 3 is a schematic sectional view of a mechanical seal arrangement having a torque device, according to a second embodiment of the invention, and

FIG. 4 is a schematic sectional view of the mechanical seal arrangement according to the second embodiment.

A mechanical seal arrangement 1 according to a first preferred embodiment of the invention is described in detail in the following with reference to FIGS. 1 and 2.

FIG. 1 is a sectional view of a mechanical seal arrangement 1 comprising a mechanical seal 2. The mechanical seal 2 comprises a rotating slide ring 3 and a stationary slide ring 4. The rotating slide ring 3 comprises a first sliding surface 30, and the stationary slide ring 4 comprises a second sliding surface 40. A sealing gap 5 is defined between the two sliding surfaces 30, 40.

The mechanical seal arrangement 1 seals a product region 11 from an atmosphere region 12 at a shaft 10.

The rotating slide ring 3 is connected by means of a first slide ring carrier 31 which is rigidly connected to the shaft 10. The stationary slide ring 4 is connected to a stationary component, for example a second slide ring carrier 41 or a housing part.

In order to transmit a torque M1 from the first slide ring carrier 31 to the rotating slide ring 3, the mechanical seal arrangement 1 comprises a torque device 6. An introduction of a torque into the rotating slide ring can take place by means of the torque device 6.

Furthermore, in particular upon startup of the machine and thus at the start of the rotation of the shaft, a supporting torque M2 results between the stationary slide ring 4 and the second slide ring carrier 41, which must also be transmitted between said two components by a torque device 6.

The torque device 6 between the rotating slide ring 3 and the first slide ring carrier 31 can be seen in detail from FIGS. 1 and 2. The torque device 6 comprises a plurality of transmission elements 60 which in this embodiment are cylindrical rolling bodies. As can be seen from FIG. 6, a total of six rolling bodies are arranged along the periphery, in a uniformly distributed manner, between the rotating slide ring 3 and the first slide ring carrier 31.

The transmission elements 6 are configured to transmit torque between the first slide ring carrier 31 and the rotating slide ring 3. In this case, the total torque M1 is divided with the same magnitude over the plurality of the individual transmission elements 61.

As can furthermore be seen from FIGS. 1 and 2, first receiving openings 61 having a cross-section that is curved are formed in the first slide ring carrier 31. Second receiving openings 62 having a cross-section that is curved are formed in the rotating slide ring 3. In this case, the transmission elements 60 are arranged both in the first and second receiving opening 61, 62.

As can furthermore be seen from FIG. 2, the cylindrical transmission element 60 has a first radius R1, the first receiving opening 61 in the first slide ring carrier 31 has a second radius R2, and the second receiving opening 62 in the rotating slide ring 3 has a third radius R3. In this case, the first radius R1 is smaller than the second radius R2 and smaller than the third radius R3. Furthermore, the second radius R2 and the third radius R3 are the same size.

As can be seen from FIG. 1, in the case of starting of the mechanical seal arrangement from the rest position, the selection of the three radii R1, R2, R3 results in a rolling movement of the transmission elements 60 in the first and second receiving opening 61, 62. In this case, a force introduction point K can be defined by the selection of the size of the radii R1, R2, R3. Since the first radius R1 is smaller than the two radii R2 and R3, the force introduction point K results, which is located at a spacing A from an edge of the second receiving opening 62 in the rotating slide ring 3. This prevents in particular the forces F occurring during the starting process of the mechanical seal arrangement from being located at the edge of the second receiving opening 62, such that chipping or crack formation at this sensitive region of the slide ring can be prevented. Thus, the force introduction point K can be positioned away from the outer periphery of the slide ring, and thus stress peaks, which could lead to chipping or the like on the slide ring can be prevented.

Furthermore, the configuration of the transmission elements 60 as rolling bodies ensures that, in the starting process, a short rolling process of the transmission elements 60 out of the rest position occurs, such that a uniformly distributed and thus smooth introduction of the torque from the first slide ring carrier 31 to the rotating slide ring 3 takes place.

Furthermore, setting the force direction of the force F to a tangent T with an angle α during the starting process by the torque M1 makes it possible for an additional radial force to be provided at each first receiving opening 61. As a result, a brief torque-active sliding surface deformation of the sliding surface 30 of the rotating slide ring, in particular on the outer periphery of the rotating slide ring, can be provided in a purposeful manner, such that a certain waviness is present in the starting process of the slide ring 30. This can cause a brief penetration of medium out of the product region 11 under high pressure into the sealing gap 5, which, in addition to the starting torque, makes a contribution to the sliding surfaces breaking away from one another out of the idle state, in order to form the sealing gap 5 between the sliding surfaces 30, 40 as quickly as possible. Since this process also occurs only very briefly, there is in general no passage of the medium out of the pressure region 11 through the forming sealing gap 5 in the direction around the atmosphere region 12. After the breakaway torque has been overcome, the torque between the first slide ring carrier 31 and the rotating slide ring 3 immediately drops, such that the sliding surfaces immediately smooth out again.

Since the same sliding surface deformation at the second sliding surface 40 of the stationary slide ring 4 results in the starting process for overcoming the breakaway torque, the brief waviness on the two sliding surfaces occurs and disappears again immediately, after the breakaway torque is overcome. Thus, this embodiment of the mechanical seal arrangement has significant advantages, in particular in the case of very high pressures in the product region 11.

Furthermore, the transmission elements 60 of the torque device 6 on the stationary slide ring 4 between the stationary slide ring 4 and the second slide ring carrier 41 are configured identically to on the rotating slide ring. In this case, a corresponding counter torque M2 acts between the stationary slide ring 4 and the second slide ring carrier 41 in the starting process, since in the starting process the rotating slide ring 3 that is in contact with the stationary slide ring 4 attempts to cause the stationary slide ring 4 to rotate. In the process, the stationary slide ring 4 is then supported, via the transmission elements 60, on the second slide ring carrier 41, and the counter torque M2 is generated at the stationary slide ring 4.

The number of the transmission elements 60 on the rotating slide ring 3 and on the stationary slide ring 4 are preferably the same.

In this case, the invention offers a solution which occurs, in the case of the mechanical seal, in particular at the time that the rotation starts at the startup time of a machine. In particular, the invention allows, without reservation, for the use of ceramic slide rings both as the rotating slide ring and as the stationary slide ring. In the prior art, there has hitherto been significant effort, by way of shrink fits, bandages, or slide ring materials having a low degree of brittleness, in order to mitigate this dangerous situation when starting the mechanical seal. Moreover, the mechanical seal of the invention furthermore makes it possible that a configuration of the mechanical seal arrangement such that upon standstill of the mechanical seal a critical operating state having a defined residual leakage through a minimal gap between the slide rings, in order to keep breakaway torques as small as possible, is not necessary.

The invention furthermore allows the use of ceramic materials for the stationary and rotating slide ring without a coating, since the starting torques of the mechanical seal arrangement according to the invention can be significantly reduced. In the prior art, diamond coatings are frequently used, in order to allow for a service life of the slide rings in the case of frequent start/stop situations with correspondingly high torques upon startup. The invention makes it possible to omit such expensive diamond coatings or the like.

The mechanical seal 1 thus allows for a significant reduction in a breakaway torque of the mechanical seal 2 in the case of a starting process. In this case, the cylindrical transmission elements 60 are preferably produced from metal, and the rotating slide ring 3 and the stationary slide ring 4 are produced from a ceramic material, in particular SiC.

FIGS. 3 and 4 show a mechanical seal arrangement 1 according to a second embodiment of the invention. Identical or functionally identical parts are denoted by the same reference signs as in the first embodiment.

The second embodiment substantially corresponds to the first embodiment, wherein in contrast with the first embodiment in the case of the second embodiment the transmission elements 70 are configured differently. In the second embodiment, the transmission elements 70 are configured such that the transmission elements 70 comprise a first body 71 and a second body 72, as well as a connection device 73. The first body 71 has a curved first contact surface 71a for contact with the first receiving opening 61 in the first slide ring carrier 31. The second body 72 has a second curved contact surface 72a for contact with the second receiving opening 62 in the rotating slide ring 3.

As can be seen from FIG. 3, the first body 71 has a smaller cross-section than the second body 72. In this case, the first body 71 has an elliptical cross-section and the second body 72 also has an elliptical cross-section. The connection device 73 comprises a plurality of rods (cf. FIG. 4) which establish a connection between the first body 71 and the second body 72. The rods of the connection device 73 have greater elasticity than the first body 71 and the second body 72. This achieves, in the starting process of the mechanical seal arrangement, a smooth torque introduction from the first slide ring carrier 31 to the rotating slide ring 3 taking place. The first and second bodies 71, 72 are rod-shaped components which extend in the axial direction X-X of the mechanical seal. The connection device 73 comprising the plurality of rods extends in the radial direction of the mechanical seal arrangement.

As is furthermore visible from FIG. 3, a radius R2 of the first receiving opening 61 is smaller than a radius R3 of the second receiving opening 62. In this case, the cross-sections of the elliptical first and second bodies 71, 72 are adjusted to the radii R2 and R3. Thus, upon the startup process, a rolling movement between the contact surfaces of the receiving openings 61, 62 and the first and second body 71, 72 occurs over a small angle of rotation, preferably of smaller than 5°. As in the first embodiment, a plurality of transmission elements 70, which are preferably all configured the same, are provided along the periphery of the rotating slide ring 3. In the same way, such transmission elements 70 can of course also be provided between the stationary slide ring 4 and the second slide ring carrier 41. Otherwise, this embodiment corresponds to the first embodiment, and therefore reference can be made to the description given there.

### LIST OF REFERENCE SIGNS

1 mechanical seal arrangement
2 mechanical seal
3 rotating slide ring
4 stationary slide ring
5 sealing gap
6 torque device
10 shaft
11 product region
12 atmosphere region
30 sliding surface
31 first slide ring carrier
40 sliding surface
41 second slide ring carrier
60 transmission element/rolling body
61 first receiving opening in the slide ring carrier
62 second receiving opening in the slide ring
70 transmission elements
71 first body
71a first contact surface
72 second body
72a second contact surface
73 connection device/rods
A spacing
F force
K force introduction point
M1 torque on the rotating slide ring
M2 counter torque on the stationary slide ring
R1 first radius of the rolling body
R2 second radius of the first receiving opening
R3 third radius of the second receiving opening
T tangent
α angle

1. Mechanical seal arrangement, comprising:
a mechanical seal having a rotating slide ring having a first sliding surface and a stationary slide ring having a second sliding surface, wherein a sealing gap is defined between the sliding surfaces,
a torque device for transmitting a torque between one of the slide rings and a slide ring carrier,
wherein the torque device comprises a plurality of transmission elements which are configured for transmitting torque between the slide ring carrier and the slide ring such that a total torque is divided over the plurality of transmission elements,
wherein the slide ring carrier comprises first receiving openings having a cross-section that is curved and the slide ring comprises second receiving openings which have a cross-section that is curved, and
wherein the transmission elements are arranged in the first and second receiving opening.

2. Mechanical seal arrangement according to claim 1, wherein the transmission elements are rolling elements which are configured for performing a rolling process between the slide ring carrier and the slide ring in the case of torque transmission.

3. Mechanical seal arrangement according to claim 2, wherein the rolling bodies are cylinders.

4. Mechanical seal arrangement according to claim 2, wherein a first radius R1 of the cylinder is smaller than a second radius R2 of the first receiving opening in the slide ring carrier, and/or wherein the first radius R1 of the cylinder is smaller than a third radius R3 of the second receiving opening in the slide ring.

5. Mechanical seal arrangement according to claim 4, wherein the second radius R2 is the same size as the third radius R3.

6. Mechanical seal arrangement according to claim 1, wherein the transmission elements comprise a first body, a second body and a connection device which connects the first body to the second body, wherein the first body comprises a curved first contact surface for contact to the first receiving opening (61) in the slide ring carrier and the second body comprises a second curved contact surface for contact with the second receiving opening in the slide ring.

7. Mechanical seal arrangement according to claim 6, wherein the connection device comprises one or more rods extending substantially in the radial direction and/or a framework-like connection.

8. Mechanical seal arrangement according to claim 6, wherein the connection device has greater elasticity than the first body and the second body.

9. Mechanical seal arrangement according to claim 6, wherein the first body and/or the second body is a rod-shaped component having an elliptical cross-section.

10. Mechanical seal arrangement according to claim 1, wherein a torque device is arranged both on the rotating slide ring and on the stationary slide ring for transmitting torque from the slide rings to the slide ring carrier.

11. Mechanical seal arrangement according to claim 1, wherein the torque device is arranged in the first receiving opening and the second receiving opening in such a way that a force introduction point K is at a spacing A from an edge of the first and second receiving opening.

12. Mechanical seal arrangement according to claim 1, wherein the rotating slide ring and/or the stationary slide ring are produced from ceramic material, and/or wherein the rotating slide ring and the stationary slide ring do not have any coating on the sliding surface.

13. Mechanical seal arrangement according to claim 1, wherein a line contact is present between the transmission elements and the first receiving opening and the second receiving opening.
